(19) United States
(12) Patent Application Publication
(10) Pub. No.: US 2022/0179092 A1
(43) Pub. Date: Jun. 9, 2022

(54) ADJUSTMENT DEVICE AND LIDAR MEASURING DEVICE

(71) Applicant: Ibeo Automotive Systems GmbH, Hamburg (DE)

(72) Inventors: Ralf Beuschel, Friedrichshafen (DE); Falko Diebel, Hamburg (DE); Michael Köhler, Hamburg (DE)

(21) Appl. No.: 17/567,025

(22) Filed: Dec. 31, 2021

Related U.S. Application Data
(63) Continuation of application No. PCT/EP2020/067226, filed on Jun. 19, 2020.

(30) Foreign Application Priority Data
Jul. 2, 2019 (DE) 102019209694.8

(51) Int. Cl. G01S 17/931; G01S 7/481

(52) U.S. Cl. CPC G01S 17/931; G01S 7/4815

(57) ABSTRACT

An adjustment device for adjusting a visual field of a Lidar measuring device in a focal plane array arrangement on a vehicle, with: a pitch angle estimating unit for determining a pitch angle (N) of the vehicle; an area unit for determining a desired object detection area in relation to an alignment of the vehicle based upon the pitch angle; a selection unit for determining a selection of rows (Z₁-Z₆) of transmitting elements of a Lidar transmitting unit of the Lidar measuring device and/or sensor elements of a Lidar receiving unit of the Lidar measuring device running parallel to a horizontal plane of the vehicle based upon the desired object detection area; and a control interface for activating the selection of rows of transmitting elements of the Lidar transmitting unit and/or sensor elements of the Lidar receiving unit of the Lidar measuring device, so as to detect objects within the object detection area. The present invention further relates to a Lidar measuring device in a focal plane array arrangement for detecting objects in an environment of a vehicle. In addition, the invention relates to a method for adjusting a visual field of a Lidar measuring arrangement in a focal plane array arrangement on a vehicle.

### CROSS REFERENCE TO RELATED APPLICATIONS

This application is a continuation of International Application No. PCT/EP2020/067226, filed on Jun. 19, 2020, which claims priority from German Patent Application No. 102019209694.8, filed on Jul. 2, 2019, the contents of each of which are incorporated by reference herein.

### FIELD OF THE INVENTION

The present invention relates to an adjustment device for adjusting a visual field of a Lidar measuring device in a focal plane array arrangement on a vehicle. The present invention further relates to a Lidar measuring device in a focal plane array arrangement for detecting objects in an environment of a vehicle. In addition, the invention relates to a method for adjusting a visual field of a Lidar measuring device.

### BACKGROUND

Modern vehicles (automobiles, transporters, trucks, motorcycles, driverless transport systems, etc.) comprise a plurality of systems that provide a driver or operator with information and/or partially or fully automatedly control individual functions of the vehicle. Sensors acquire the environment of the vehicle along with other possible road users. Based upon the acquired data, a model of the vehicle environment can then be generated, and changes in this vehicle environment can be reacted to. Continued development in the field of autonomously and partially autonomously driving vehicles is leading to an ever-growing influence and sphere of action with respect to driver assistance systems (advanced driver assistance systems, ADAS) and autonomously operating transport systems. The development of ever more precise sensors is making it possible to acquire the environment and completely or partially control individual functions of the vehicle without any intervention by the driver.

Lidar (light detection and ranging) technology here constitutes one important sensor principle for acquiring the environment. A Lidar sensor is based upon transmitting light pulses and detecting the reflected light. A distance to the place of reflection can be calculated by means of a runtime measurement. A target can be detected by evaluating the received reflections. With regard to the technical implementation of the corresponding sensor, a distinction is made between scanning systems, which most often function based upon micromirrors, and non-scanning systems, in which several transmitting and receiving elements are statically arranged one next to the other (in particular so-called focal plane array arrangement).

In this conjunction, WO 2017/081294 A1 describes a method and a device for optical distance measurement. The use of a transmitting matrix for transmitting measuring pulses and a receiving matrix for receiving the measuring pulses are described. When transmitting the measuring pulses, subsets of the transmitting elements of the transmitting matrix are activated.

One challenge when detecting objects by means of a Lidar lies in the fact that tolerances arise during the manufacture and during the installation of corresponding sensors in a vehicle. These can lead to a suboptimal utilization of the visual field of the sensor or to a loss in accuracy. In addition, deviations in the alignment or location of the vehicle from the normal state can arise during operation of the vehicle, which likewise can alter the alignment of the visual field. Such deviations in operation can be dynamic (for example, when braking or cornering) or also static (for example due to a cargo). In order to achieve a sufficient reliability for the sensor, an oversized visual field is therefore often used or read out, so that all objects in the relevant area are acquired even given deviations in alignment. This leads to high costs and/or a poorer resolution.

### SUMMARY

Proceeding from the above, the object of the present invention is to provide an approach toward better detecting objects in a visual field of a Lidar measuring device. In particular, the highest possible resolution in a relevant area is to be achieved.

In order to achieve this object, the invention in a first aspect relates to an adjustment device for adjusting a visual field of a Lidar measuring device in a focal plane array arrangement on a vehicle, with:

a pitch angle estimating unit for determining a pitch angle of the vehicle;

an area unit for determining a desired object detection area in relation to an alignment of the vehicle based upon the pitch angle;

a selection unit for determining a selection of rows of transmitting elements of a

Lidar transmitting unit of the Lidar measuring device and/or sensor elements of a Lidar receiving unit of the Lidar measuring device running parallel to a horizontal plane of the vehicle based upon the desired object detection area; and

a control interface for activating the selection of rows of transmitting elements of the Lidar transmitting unit and/or sensor elements of the Lidar receiving unit of the Lidar measuring device, so as to detect objects within the object detection area.

In another aspect, the invention relates to a Lidar measuring device in a focal plane array arrangement for detecting objects in an environment of a vehicle, with:

a Lidar transmitting unit with a plurality of transmitting elements for transmitting light pulses and a Lidar receiving unit with a plurality of sensor elements for receiving the light pulses, wherein the transmitting elements and the sensor elements are arranged in rows that run parallel to a horizontal plane of the vehicle;

and

an adjustment device as defined above.

Additional aspects of the invention relate to a method configured according to the adjustment device and a computer program product with program code for implementing the steps of the method when the program code is run on a computer, as well as a storage medium that stores a computer program, which when run on a computer causes the method described herein to be implemented.

Preferred embodiments of the invention will be described in the dependent claims. It is understood that the features mentioned above and yet to be described below can be used not only in the respectively indicated combination, but also in other combinations or on their own, without departing from the framework of the present invention. In particular, the adjustment device, the Lidar measuring device as well as the method and the computer program product can be configured according to the embodiments described for the adjustment device or the Lidar measuring device in the dependent claims.

The pitch angle of a vehicle can change during the ride, for example due to the cargo or due to a driving maneuver (braking, accelerating, etc.). Given an immovably installed sensor in a focal plane array arrangement, the latter is fixed in its position in relation to the vehicle. To be able to detect objects in the relevant area despite the pitching motion, the visual range selected for the sensor must be sufficiently large in terms of its vertical expansion. As a result, in themselves irrelevant areas are evaluated so as to still cover the relevant area in the event of a pitching motion of the vehicle. It is likewise possible that inaccuracies in alignment arise during production or while fastening the sensor to the vehicle. These must likewise be compensated by a selected visual field for the Lidar transmitting unit and the Lidar receiving unit that is in itself too large.

The invention provides that a pitch angle of the vehicle initially be determined. Based upon the pitch angle, a desired object detection area is then determined. This object detection area corresponds to a portion of the visual field of the Lidar transmitting unit or the Lidar receiving unit. The desired object detection area is the portion of the visual field in which objects are to be detected by means of the Lidar measuring device. In this regard, the object detection area constitutes an area within which objects are expected. Proceeding from the determined desired object detection area, rows of transmitting elements and/or rows of sensor elements of the Lidar measuring device are selected, which are then activated to detect objects within the object detection area. As a consequence, the invention provides that not the complete possible visual field of the Lidar measuring device be activated and evaluated, but only a portion thereof. Unneeded portions of the visual field are not used.

This makes it possible to save energy for transmitting the light pulses (laser power) and also for information processing. Furthermore, a time budget for a process of scanning unneeded rows can be economized. It is possible for the rows of transmitting elements or rows of sensor elements allocated to the object detection area to be evaluated with a higher precision. This enables an improved detection of dark objects (for example, obstacles on the roadway). In this respect, the invention yields an improved detection accuracy. The safety of autonomously driving vehicles can be improved.

In a preferred embodiment, the adjustment device comprises an environmental sensor interface for receiving environmental sensor data of an environmental sensor. The pitch angle estimating unit is configured to determine the pitch angle based upon the environmental sensor data. The environmental sensor data preferably comprise point-cloud data of the Lidar measuring device with information about objects in an environment of the vehicle. For example, data of a camera or a radar sensor can be received as environmental sensor data. Data of the Lidar measuring device are preferably processed. The pitch angle can be determined proceeding from these environmental sensor data. The advantage to this is that the pitch angle of the vehicle can be exactly determined in relation to the environment of the vehicle. A precise determination of the pitch angle becomes possible. When using the data of the Lidar measuring device, it is not necessary to access external data.

In a preferred embodiment, the pitch angle estimating unit is configured to detect a horizontal position based upon the environmental sensor data. The pitch angle estimating unit is further configured to determine the pitch angle based upon the horizontal position. The horizon is detected. To this end, for example, the plane in which the roadway of the vehicle is met at a prescribed distance can be detected. It is likewise possible to detect as of which height (as of which row of sensor elements) a roadway is no longer detected. This yields a precise and situationally adequate estimate of the pitch angle.

In another preferred embodiment, the pitch angle estimating unit is configured to detect a roadway progression in an immediate vicinity of the vehicle based upon the environmental sensor data. The pitch angle estimating unit is further configured to determine the pitch angle based upon the roadway progression. The roadway is detected in the immediate vicinity of the vehicle. For example, the plane of the sensor in which or with which row of sensor elements the roadway is detected in the immediate vicinity can be recognized. This yields an accurate estimation of the pitch angle without having to access external data.

In a preferred embodiment, the adjustment device comprises a position sensor interface for receiving position sensor data of a position sensor on the vehicle. The pitch angle estimating unit is configured to determine the pitch angle based upon the position sensor data. If a position sensor is additionally present, a determination of the pitch angle can take place based upon its data. This results in an easy to realize and precisely estimated pitch angle. Computing power can be saved.

In a preferred embodiment, the area unit is configured to determine the desired object detection area based upon a predefined angle parameter. For example, the object detection area can describe a fixed angle range around a plane parallel to the roadway. Varying upper and lower deviations can likewise be defined in the predefined angle parameter. This yields an easy to realize determination of the desired object detection area.

In a preferred embodiment of the Lidar measuring device, the Lidar measuring device is configured for attachment to a vehicle in an area of a bumper of the vehicle. For example, the Lidar measuring device can be integrated into a bumper of the vehicle. This results in a clear view of objects in front or back of the vehicle. However, the position on the bumper is susceptible to a pitching motion of the vehicle.

In a preferred embodiment of the Lidar measuring device, the Lidar transmitting unit and the Lidar receiving unit have a vertical visual field of 15° to 25°, preferably 20°. A visual field center of the vertical visual field runs parallel to the horizontal plane (longitudinal plane) of the vehicle. A comparatively large vertical visual field of the Lidar transmitting unit and the Lidar receiving unit creates a sufficient basis for selecting the object detection area.

A focal plane array arrangement is understood as a configuration of the sensor elements (or transmitting elements) essentially in one plane. In particular, a Lidar receiving unit is a microchip with the corresponding sensor elements. The receiving and transmitting units can also be arranged together on a microchip. The sensor elements are arranged on a chip in matrix form. The sensor elements are distributed over a surface of the chips of the Lidar receiving unit. One or several sensor elements are allocated to a transmitting element. A light pulse of a Lidar transmitting unit is understood in particular as a pulse of laser light. An environment of a vehicle in particular comprises an area around the vehicle visible from the vehicle. The pitch angle (English pitch angle) is the position angle of the vehicle that describes or quantifies pitch or tamping movement. The pitch angle quantifies a rotation around a transverse axis (pitch axis) of the vehicle. The transverse axis is the body axis standing transverse to the normal direction of movement of the vehicle. The horizontal plane of the vehicle is parallel to a longitudinal and a transverse axis of the vehicle.

### BRIEF DESCRIPTION OF THE DRAWINGS

The invention will be described and explained in more detail below based upon several selected exemplary embodiments in conjunction with the attached drawings. Shown on:

FIG. 1 is a schematic view of a Lidar measuring device according to one aspect of the present invention;

FIG. 2 is a schematic view of an adjustment device according to the invention;

FIG. 3 is a schematic view of an adjusted visual field of a Lidar measuring device;

FIG. 4 is a schematic view of a Lidar transmitting unit;

FIG. 5 is a schematic view of a vehicle with a Lidar measuring device according to the invention; and

FIG. 6 is a schematic view of a method according to the invention.

### DETAILED DESCRIPTION OF THE PREFERRED EMBODIMENTS

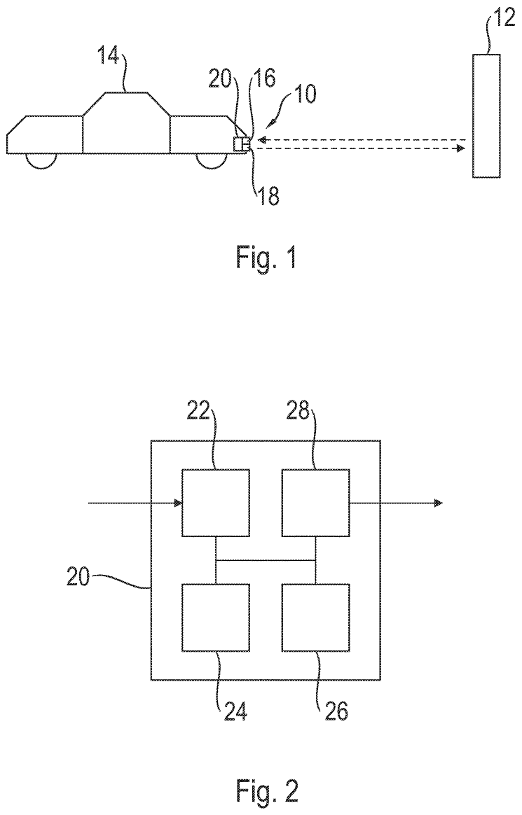

Schematically depicted on FIG. 1 is a Lidar measuring device 10 according to the invention for detecting an object 12 in an environment of a vehicle 14. In the exemplary embodiment shown, the Lidar measuring device 10 is integrated into the vehicle 14. For example, the object 12 in the environment of the vehicle 14 can be another vehicle or also a static object (traffic sign, house, tree, etc.) or another road user (pedestrian, bicyclist, etc.). The Lidar measuring device 10 is preferably mounted in the area of a bumper of the vehicle 14, and can in particular evaluate the environment of the vehicle 14 in front of the vehicle. For example, the Lidar measuring device 10 can be integrated into the front bumper.

The Lidar measuring device 10 comprises a Lidar receiving unit 16 as well as a Lidar transmitting unit 18. The Lidar measuring device 10 further comprises an adjusting device 20 for adjusting a visual field of the Lidar measuring device 10.

Both the Lidar receiving unit 16 and the Lidar transmitting unit 18 are preferably configured in a focal plane array configuration. The elements of the respective device are essentially arranged in a plane on a corresponding chip. The chip of the Lidar receiving unit or the Lidar transmitting unit is arranged in a focal point of a corresponding optical system (transmitting optics or receiving optics). In particular, sensor elements of the Lidar receiving unit 16 or transmitting elements of the Lidar transmitting unit 18 are arranged in the focal point of the respective receiving or transmitting optics. For example, these optics can consist of an optical lens system.

The sensor elements of the Lidar receiving unit 16 are preferably configured as a SPAD (single photon avalanche diode). The Lidar transmitting unit 18 comprises several transmitting elements for transmitting laser light or laser pulses. The transmitting elements are preferably configured as a VCSEL (vertical cavity surface emitting laser). The transmitting elements of the Lidar transmitting unit 18 are distributed over a surface of a transmitting chip. The sensor elements of the Lidar receiving unit 16 are distributed over a surface of the receiving chip.

The transmitting chip has allotted to it transmitting optics, and the receiving chip has allotted to it receiving optics. The optics image the incoming light from a space region on the respective chip. The space region corresponds to the visual area of the Lidar measuring device 10, which is examined or sensed for objects 12. The space region of the Lidar receiving unit 16 or the Lidar transmitting unit 18 is essentially identical. The transmitting optics image a transmitting element onto a spatial angle that represents a partial area of the space region. The transmitting element sends laser light out into this spatial angle accordingly. The transmitting elements together cover the entire space region. The receiving optics image a sensor element onto a spatial angle that represents a partial area of the space region. The number of all sensor elements covers the entire space region. Transmitting elements and sensor elements that examine the same spatial angle image onto each other, and are accordingly allotted or allocated to each other. In normal cases, a laser light of a transmitting element is always imaged onto the accompanying sensor element. It is favorable that several sensor elements be arranged inside of the spatial angle of a transmitting element.

In order to determine or detect objects 12 inside of the space region, the Lidar measuring device 10 performs a measuring process. Such a measuring process comprises one or several measuring cycles, depending on the structural design of the measuring system and its electronics. A TCSPC (time correlated single photon counting) method is here preferably used in the control unit 20. Individual incoming photons are here detected, in particular via an SPAD, and the time at which the sensor element is triggered (detection time) is stored in a memory element. The detection time is correlated with a reference time at which the laser light is transmitted. The difference can be used to ascertain the runtime of the laser light, from which the distance of the object 12 can be determined.

A sensor element of the Lidar receiving unit 16 can be triggered by the laser light on the one hand, and by background radiation on the other. At a specific distance of the object 12, a laser light always arrives at the same time, whereas the background radiation provides the same probability of triggering a sensor element at any time. When a measurement is performed multiple times, in particular in several measuring cycles, the triggerings of the sensor element add up at the detection time that corresponds to the runtime of the laser light in relation to the distance of the object. By contrast, triggerings caused by the background radiation are uniformly distributed over the measuring duration of a measuring cycle. One measurement corresponds to the transmission and subsequent detection of the laser light. The data from the individual measuring cycles of a measuring process stored in the memory element make it possible to evaluate the detection times that were determined several times, so as to infer the distance of the object 12.

A sensor element is favorably connected with a TDC (time to digital converter). The TDC stores the time at which the sensor element was triggered in the memory element. For example, such a memory element can be configured as a short-term memory or a long-term memory. The TDC fills a memory element with the times at which the sensor elements detect an incoming photon for a measuring process. This can be graphically depicted by a histogram, which is based upon the data of the memory element. In a histogram, the duration of a measuring cycle is divided into very short time segments (so-called bins). If a sensor element is triggered, the TDC increases the value of a bin by 1. The bin corresponding to the runtime of the laser pulse is filled, meaning the difference between the detection time and reference time.

FIG. 2 schematically depicts an adjustment device 20 according to the invention for adjusting a visual field of a Lidar measuring device. The adjustment device 20 comprises a pitch angle estimating unit 22, an area unit 24, a selection unit 26 as well as a control interface 28. In addition, the adjustment device 20 can also comprise an environmental sensor interface, via which the environmental sensor data of an environmental sensor can be received, and/or a position sensor interface, via which the position sensor data of a position sensor can be received (not shown). The various units and interfaces can be configured or implemented in software and/or hardware, whether individually or combined. In particular, the units can be implemented in software run on a processor of the Lidar measuring device.

For example, the pitch angle estimating unit 22 can be configured to receive data of a position sensor and/or to receive data of an environmental sensor, and to determine the pitch angle of the vehicle based thereupon. The pitch angle is then determined or calculated by means of a corresponding evaluation. Point-cloud data of the Lidar measuring device are preferably evaluated, for example to determine or track a horizontal position, i.e., a progression of a horizon, or a roadway progression, i.e., an alignment of the roadway in an area in front of the vehicle.

The area unit 24 can determine the object detection area, for example based upon a predefined angle parameter (which can also be two-dimensional). In particular, the angle parameter can here describe an upward or downward deviation from a plane of the roadway or from a horizontal plane.

The evaluation unit 26 is used to select rows of transmitting elements and/or rows of sensor elements. It is possible both that only portions of the transmission elements be activated, and that only portions of the sensor elements be read out. It is likewise possible that both rows of transmitting elements and rows of sensor elements be selected.

The corresponding selection of rows is activated via the control interface 28. The control interface 28 is configured to correspondingly actuate the Lidar measuring device or a processor of the Lidar measuring device.

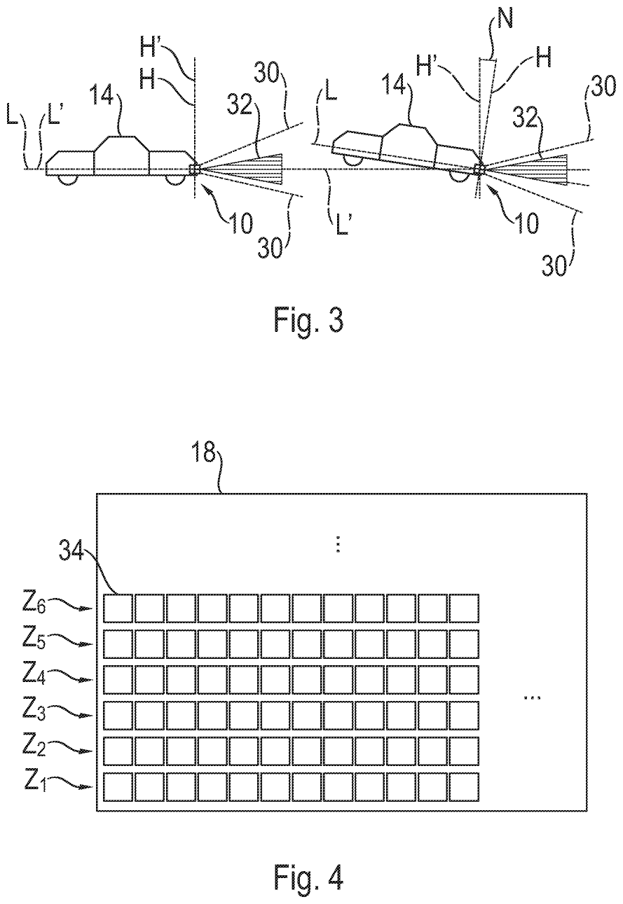

FIG. 3 schematically depicts how the visual field 30 of the vehicle 14 changes when the vehicle 14 pitches, for example due to a braking process. The vehicle 14 is shown in a normal alignment on the left side. In the sectional view shown, the Lidar receiving unit 16 or the Lidar transmitting unit 18 can have a vertical visual field 30 of 20° (visual field with an opening angle of 20°), for example. The visual field center of the visual field runs parallel to a longitudinal axis L of the vehicle 14 (parallel to a horizontal plane of the vehicle). The longitudinal axis L runs congruently to a corresponding axis L′ of the reference system (horizontal line). The vertical axis H of the vehicle 14 stands perpendicularly on the roadway, and runs congruently to a corresponding vertical axis H′ of the reference system. In this normal state of the vehicle 14, the Lidar measuring device 10 can detect objects within of the entire visual field 30, but it is sufficient that objects be acquired within an object detection area 32. For example, the object detection area can comprise an area of ±5° relative to the horizontal line. The object detection area 32 can also be referred to as an active visual field.

Shown on the right side of FIG. 3 is the situation where the vehicle 14 performs a pitching motion with a pitch angle N. The longitudinal axis L or the vertical axis H are inclined relative to the corresponding axes L′, H′ of the reference system. Because the Lidar measuring device 10 is fixedly connected with the vehicle 14, the visual field of the Lidar measuring device or the Lidar transmitting unit and the Lidar receiving unit is also inclined. The adjustment device according to the invention makes it possible to select the object detection area 32 in such a way that only the same area of ±5° relative to the horizontal line is always selected as he active visual field, and objects within this area can be detected. The visual field 30 of the Lidar measuring device 10 is only partially used, so to speak.

The situation depicted for a braking maneuver must be understood as exemplary. Cargo on the vehicle 14 or a tolerance error in the alignment of the Lidar measuring device 10 in the vehicle also results in an adjustment of the visual field or a selection of an observation area being necessary or expedient if the Lidar measuring device 10 has a sufficiently large visual field.

FIG. 4 schematically depicts a Lidar transmitting unit 18 according to the invention. The Lidar transmitting device 18 comprises a plurality of transmitting elements 34, which are arranged in a plurality of rows Z₁-Z₆. For purposes of clarity, the drawing only shows several rows or a selection of the transmitting elements 34. For example, the Lidar transmitting unit can comprise an array with 128*128 transmitting elemen 34.

The transmitting elements 34 can be activated row by row. This means that all transmitting elements 34 arranged in the same row Z₁-Z₆ can be activated simultaneously.

Because the Lidar transmitting unit 18 is configured in a focal plane array arrangement and fixedly connected with the vehicle or built into the vehicle, the alignment of the arrays of the Lidar transmitting unit 18 relative to the vehicle cannot be changed during operation. Therefore, if a tolerance arises during installation or if the vehicle performs a pitching motion, an alignment of the Lidar transmitting unit relative to the reference system (the street, the horizon, etc.) changes. According to the invention, only a selection of the rows Z₁-Z₆ is activated, so as to economize on energy on the one hand, and be able to actuate the remaining rows of the desired object detection area at a higher frequency on the other.

Let it be understood that the Lidar receiving unit with sensor elements is configured correspondingly to the Lidar transmitting unit 18. The Lidar transmitting unit 18 and the Lidar receiving unit 16 are usually fixedly connected with each other, and preferably arranged one next to the other, so that the alignment of both changes when the vehicle performs a movement. Analogously to actuating the transmitting elements 34 of the Lidar transmitting unit 18, the sensor elements of the Lidar receiving unit 16 can also be read out row by row. This makes it possible to economize on more energy or increase the readout frequency.

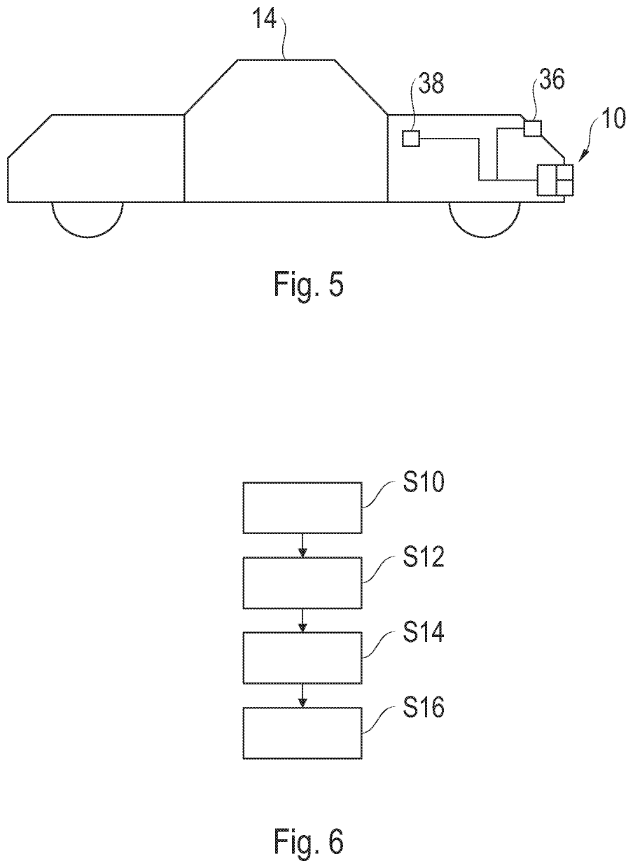

FIG. 5 schematically depicts a vehicle 14 with a Lidar measuring device 10 according to the invention. In addition to the Lidar measuring device 10, the vehicle comprises an environmental sensor 36 along with a position sensor 38. For example, the environmental sensor 36 can comprise a camera, and be arranged outside of the Lidar measuring device 10. For example, the position sensor 38 can comprise an inertial measuring unit, and likewise be arranged outside of the Lidar measuring device 10 in the vehicle 14.

FIG. 6 schematically depicts a method according to the invention for adjusting a visual field of a Lidar measuring device in a focal plane array arrangement on a vehicle. The vehicle comprises the steps of determining S10 a pitch angle, determining S12 a desired object detection area, determining S14 a selection of rows and activating S16 the selection of rows. For example, the method can be implemented in software that is run on a processor of a Lidar measuring device.

The invention was comprehensively described and explained based upon the drawings and the specification. The specification and explanation are to be construed as an example, and not as limiting. The invention is not limited to the disclosed embodiments. Other embodiments or variations arise for the skilled person during the use of the present invention as well as during a precise analysis of the drawings, the disclosure, and the following claims.

In the claims, the words “comprise” and “with” do not rule out the presence of additional elements or steps. The undefined article “a” or “an” does not preclude the presence of a plurality. A single element or a single unit can perform the functions of several units mentioned in the claims. An element, a unit, an interface, a device, and a system can be partially or completely converted into hardware and/or software. The mere mention of several measures in several different dependent claims must not be taken to mean that advantageous use could likewise not be made of a combination of these measures. A computer program can be stored/distributed on a nonvolatile data carrier, for example on an optical memory or on a solid state drive (SSD). A computer program can be distributed together with hardware and/or as part of a hardware, for example by means of the internet or by means of hardwired or wireless communication systems. Reference numbers in the claims are not to be understood as limiting.

1. An adjustment device for adjusting a visual field of a Lidar measuring device in a focal plane array arrangement on a vehicle, with:
a pitch angle estimating unit for determining a pitch angle (N) of the vehicle;
an area unit for determining a desired object detection area in relation to an alignment of the vehicle based upon the pitch angle;
a selection unit for determining a selection of rows (Z₁-Z₆) of transmitting elements of a Lidar transmitting unit of the Lidar measuring device and/or sensor elements of a Lidar receiving unit of the Lidar measuring device running parallel to a horizontal plane of the vehicle based upon the desired object detection area; and
a control interface for activating the selection of rows of transmitting elements of the Lidar transmitting unit and/or sensor elements of the Lidar receiving unit of the Lidar measuring device, so as to detect objects within the object detection area.

2. The adjustment device according to claim 1, with
an environmental sensor interface for receiving environmental sensor data of an environmental sensor, wherein the pitch angle estimating unit is configured to determine the pitch angle based upon the environmental sensor data; and
the environmental sensor data preferably comprise point-cloud data of the Lidar measuring device with information about objects in an environment of the vehicle.

3. The adjustment device according to claim 2, wherein the pitch angle estimating unit is configured to detect a horizontal position based upon the environmental sensor data; and
to determine the pitch angle based upon the horizontal position.

4. The adjustment device according to claim 2, wherein the pitch angle estimating unit is configured to detect a roadway progression in an immediate vicinity of the vehicle based upon the environmental sensor data; and
to determine the pitch angle based upon the roadway progression.

5. The adjustment device according to claim 1, with a position sensor interface for receiving position sensor data of a position sensor on the vehicle, wherein the pitch angle estimating unit is configured to determine the pitch angle based upon the position sensor data.

6. The adjustment device according to claim 1, wherein the area unit is configured to determine the desired object detection area based upon a predefined angle parameter.

7. A Lidar measuring device in a focal plane array arrangement for detecting objects in an environment of a vehicle, with:
a Lidar transmitting unit with a plurality of transmitting elements for transmitting light pulses and a Lidar receiving unit with a plurality of sensor elements for receiving the light pulses, wherein the transmitting elements and the sensor elements are arranged in rows (Z₁-Z₆) that run parallel to a horizontal plane of the vehicle; and
an adjustment device for adjusting a visual field of a Lidar measuring device in a focal plane array arrangement on a vehicle, with:
a pitch angle estimating unit for determining a pitch angle (N) of the vehicle;
an area unit for determining a desired object detection area in relation to an alignment of the vehicle based upon the pitch angle;
a selection unit for determining a selection of rows (Z₁-Z₆) of transmitting elements of a Lidar transmitting unit of the Lidar measuring device and/or sensor elements of a Lidar receiving unit of the Lidar measuring device running parallel to a horizontal plane of the vehicle based upon the desired object detection area; and
a control interface for activating the selection of rows of transmitting elements of the Lidar transmitting unit and/or sensor elements of the Lidar receiving unit of the Lidar measuring device, so as to detect objects within the object detection area.

8. The Lidar measuring device according to claim 7, wherein the Lidar measuring device is configured for attachment to a vehicle in an area of a bumper of the vehicle.

9. The Lidar measuring device according to claim 7, wherein the Lidar transmitting unit and the Lidar receiving unit have a vertical visual field of 15° to 25°, preferably 20°; and a visual field center of the vertical visual field runs parallel to the horizontal plane of the vehicle.

10. A method for adjusting a visual field of a Lidar measuring device in a focal plane array arrangement on a vehicle, with the following steps:
determining (S10) a pitch angle of the vehicle;
determining (S12) a desired object detection area in relation to an alignment of the vehicle based on the pitch angle;
determining (S14) a selection of rows (Z₁-Z₆) of transmitting elements of a Lidar transmitting unit of the Lidar measuring device and/or sensor elements of a Lidar receiving unit of the Lidar measuring device running parallel to a horizontal plane of the vehicle based upon the desired object detection area; and
activating (S16) the selection of rows of transmitting elements of the Lidar transmitting unit and/or sensor elements of the Lidar receiving unit of the Lidar measuring device, so as to detect objects within the object detection area.

11. A computer program product with program code for performing the steps of the method according to claim 10 if the program code is run on a computer.
